(19) United States
(12) Patent Application Publication
(10) Pub. No.: US 2023/0254678 A1
(43) Pub. Date: Aug. 10, 2023

(54) SETUP OF A MOBILE DEVICE WITH A CARRIER PROFILE AND eSIM

(71) Applicant: Unibeam Ltd., Hod-HaSharon (IL)

(72) Inventor: Ran BEN-DAVID, Hod-HaSharon (IL)

(73) Assignee: Unibeam Ltd., Hod-HaSharon (IL)

(21) Appl. No.: 17/836,026

(22) Filed: Jun. 9, 2022

Related U.S. Application Data
(63) Continuation-in-part of application No. 17/667,597, filed on Feb. 9, 2022.

(51) Int. Cl. H04W 8/04; H04W 8/18; H04W 60/04

(52) U.S. Cl. CPC H04W 8/04; H04W 8/183; H04W 60/04

(57) ABSTRACT

A method for on-device setup, comprises: using at least one processor of a mobile device for: executing a carrier profile including an applet stored in a storage component of circuitry of the mobile device, and triggering, by the applet stored in the storage component of the circuitry, initiation of a registration process for registration with a service provider for establishing cellular communication with the service provider using the circuitry in association with the carrier profile.

### RELATED APPLICATIONS

This application is a Continuation-in-Part (CIP) of U.S. Pat. Application No. 17/667,597 filed on Feb. 9, 2022, the contents of which are all incorporated by reference as if fully set forth herein in their entirety.

### FIELD AND BACKGROUND OF THE INVENTION

The present invention, in some embodiments thereof, relates to embedded subscriber identify modality (eSIM) and, more specifically, but not exclusively, to systems and methods for establishing cellular communication with a mobile device via an eSIM and carrier profile.

An eSIM is a programmable SIM card, that operates like a physical SIM card, but allows a user to switch carriers digitally, using the same eSIM, without changing physical SIM cards. The user simply downloads a new carrier profile and releases the previous carrier profile, without changing the physical eSIM card.

### SUMMARY OF THE INVENTION

According to a first aspect, a method for on-device setup, comprises: using at least one processor of a mobile device for: executing a carrier profile including an applet stored in a storage component of circuitry of the mobile device, and triggering, by the applet stored in the storage component of the circuitry, initiation of a registration process for registration with a service provider for establishing cellular communication with the service provider using the circuitry in association with the carrier profile.

According to a second aspect, a system for on-device setup, comprises: at least one processor of a mobile device executing a code for: executing a carrier profile including an applet stored in a storage component of circuitry of the mobile device, and triggering, by the applet stored in the storage component of the circuitry, initiation of a registration process for registration with a service provider for establishing cellular communication with the service provider using the circuitry in association with the carrier profile.

According to a third aspect, a non-transitory medium of a mobile device storing program instructions for on-device setup, which, when executed by a processor of the mobile device, cause the processor to: execute a carrier profile including an applet stored in a storage component of circuitry of the mobile device, and trigger, by the applet stored in the storage component of the circuitry, initiation of a registration process for registration with a service provider for establishing cellular communication with the service provider using the circuitry in association with the carrier profile.

In a further implementation form of the first, second, and third aspects, further comprising sending and receiving data over a cellular communication network using a registration account established by the registration process.

In a further implementation form of the first, second, and third aspects, further comprising: monitoring the registration process by the applet for detecting a lack of initiation or pause in progress, and in response to detecting the lack of initiation or pause, sending by the applet a message to the server of the service provider for releasing the carrier profile from the mobile device.

In a further implementation form of the first, second, and third aspects, further comprising adapting the carrier profile to render the carrier profile inoperable for use for cellular communication.

In a further implementation form of the first, second, and third aspects, wherein render the carrier profile inoperable comprises deleting code of the carrier profile.

In a further implementation form of the first, second, and third aspects, monitoring the registration process for detecting a lack of initiation or pause in progress comprises: monitoring a message presented on a display for detecting whether a user performs one of: entering an indication to confirm to proceed with the registration process, entering an indication to terminate the registration process, and not providing a selection with respect to the registration process.

In a further implementation form of the first, second, and third aspects, the applet monitors a process running on the mobile device that enables performing the registration process via a communication session established between the applet and the process via a virtual interface of the applet.

In a further implementation form of the first, second, and third aspects, further comprising monitoring use of the carrier profile by the applet for detecting lack of use of the carrier profile exceeding a time threshold, and in response to detecting the lack of use of the carrier profile, sending by the applet a message to a server of the service provider for releasing the carrier profile from the mobile device.

In a further implementation form of the first, second, and third aspects, the carrier profiled with applet therein is obtained from a server over a limited package cellular network.

In a further implementation form of the first, second, and third aspects, the registration process is triggered automatically by the applet upon completion of download and installation of the carrier profile.

In a further implementation form of the first, second, and third aspects, the applet triggers a message presented on a display of the mobile device for initiating the registration process in response to an indication entered by a user.

In a further implementation form of the first, second, and third aspects, the applet triggers a connection over a limited cellular network to a web page hosting the registration process.

In a further implementation form of the first, second, and third aspects, further comprising, accessing by the applet, a unique identifier that uniquely identifies the circuitry for validating that the carrier profile is installed on a real physical mobile device.

In a further implementation form of the first, second, and third aspects, the unique identifier is selected from a group comprising: a unique embedded identity document (EID), eSIM ID, and International Mobile Equipment Identity (IMEI).

In a further implementation form of the first, second, and third aspects, further comprising sending a message indicating the unique identifier to a server for establishment of the cellular communication over a cellular network.

In a further implementation form of the first, second, and third aspects, the circuitry comprises an embedded subscriber identity module (eSIM) and the carrier profile comprises an eSIM carrier profile.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

### BRIEF DESCRIPTION OF THE SEVERAL VIEWS OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a block diagram of components of a system for on-device setup of a mobile device using an applet within a carrier profile, in accordance with some embodiments of the present invention;

FIG. 2 is a flowchart of a method of on-device setup of a mobile device using an applet within a carrier profile, in accordance with some embodiments of the present invention; and

FIG. 3 is an example of dataflow for establishing cellular communication with a mobile device using an applet within a carrier profile, in accordance with some embodiments of the present invention.

### DESCRIPTION OF SPECIFIC EMBODIMENTS OF THE INVENTION

The present invention, in some embodiments thereof, relates to eSIM and, more specifically, but not exclusively, to systems and methods for establishing cellular communication with a mobile device via an eSIM and carrier profile.

As used herein, the term eSIM card or eSIM represents an exemplary implementation of a circuity that is used by devices for cellular communication provided by a service provider. The term eSIM is used as a not necessarily limiting example, as other implementations of circuitry may be used. The term smart card may be used interchangeably with the term circuitry.

As used herein, the term mobile device represents an exemplary implementation of a computing device. The term mobile device is not necessarily limiting, and other devices that may be authenticated for cellular communication by a service provider, optionally using circuitry (e.g., eSIM that is embedded directly into the mobile device) installed therein, may be used.

An aspect of some embodiments of the present invention relates to systems, methods, a device, circuitry, and/or code instructions (stored on the circuitry and/or other data storage device) for on-device setup for establishing cellular communications for a mobile device. A carrier profile that includes an applet is obtained, and stored in a storage component of circuitry of the mobile device. Optionally the circuitry is an eSIM. The carrier profile with applet therein is executed. The applet automatically triggers an initiation of a registration process for registration with a service provider for establishing cellular communication with the service provider using the circuitry in association with the carrier profile. The automated local initiation of the registration process improves a user experience in setting up the eSIM with carrier profile for obtaining cellular services. For example, the applet presents a pop-up on a display of the mobile device requesting that the user click ‘OK’ to continue with the registration process. In another example, the applet opens a web browser to a server hosting a web page for preforming the registration process. Once the registration process is complete, the mobile device may access a cellular network using the carrier profile executing om the eSIM.

Optionally, the applet monitors the registration process to determine whether the registration process is proceeding. For example, the applet may monitor whether the user presses a cancel icon on the message presented on the display by the applet, to cancel the registration process. In another example, the applet may monitor lack of use of the carrier profile for a defined amount of time. The applet may send a message to a server of the cellular provider, indicating that the carrier profile may be released, enabling the carrier profile to be provided to another eSIM of another mobile device. The applet may delete code of the carrier profile to enable release of the carrier profile and/or prevent attempts to register and/or use the carrier profile.

At least some implementation of the systems, methods, devices, and code instructions described herein address the technical problem of improving a user experience in setting up a mobile device with eSIM and carrier profile for cellular communication over a cellular network. At least some implementation of the systems, methods, devices, and code instructions described herein improve the technical field of human-machine interactions, for improving a user experience in setting up a mobile device with eSIM and carrier profile for cellular communication over a cellular network. At least some implementation of the systems, methods, devices, and code instructions described herein address the technical problem, and/or improve the technical field, over existing approaches.

In one existing approach, a user first selects their desired carrier that will provide cellular communication services to their mobile device (e.g., smartphone) having an eSIM installed therein. The user is instructed to connect their mobile device to a wireless non-cellular network, for example, the internet via Wi-Fi. The user is then instructed to download an application of the desired carrier. The application guides the user to provide data and/or select configuration parameters, such as select a tariff (e.g., subscription plan), select payment method (e.g., credit card), and run an online ID verification to verify the user credentials. A carrier profile is then downloaded over the non-cellular network to the mobile device. The carrier profile is installed in association with the eSIM. The carrier provides cellular communication services to the mobile device via the eSIM and carrier profile, based on the user provided data and/or selected parameters. Such process is cumbersome for the user, as the user is required to perform many separate steps manually.

In another existing approach, the user obtains a QR code from the carrier by contacting the carrier (e.g., obtained from a store, mailed to the user after calling the carrier, sent digitally to the user in response to a request of the user). The QR code may be generic, where scanning the QR code links the mobile device to a website on a server of the carrier to provide data and/or select configuration parameters as discussed above. The QR code may be personalized for the user, where scanning the QR code links the mobile device to a user profile that has been pre-established by the carrier using the data and/or selected configuration parameters provided by the user in advance. Such process is also cumbersome for the user, as the user is required to perform many separate steps manually.

At least some implementation of the systems, methods, devices, and code instructions described herein address the above mentioned technical problem, and/or improve the above mentioned technical field, and/or improve upon the above mentioned existing approaches, by providing an applet that is included within the carrier profile that is provided for activation with the circuitry (e.g., eSIM). The improvement in the user experience and/or human-machine interaction is provided by the applet that automatically triggers the initiation of the registration process to allow the carrier profile and eSIM to access the cellular network. The automated triggering of the registration process is in contrast to existing approaches in which the user is required to perform multiple manual steps.

The systems, methods, apparatus, and/or code instructions described herein do not simply perform automation of a manual procedure, but perform additional automated features which cannot be performed manually by a human using pencil and/or paper. The applet described herein, which automatically triggers the initiation of the registration process (e.g., by generating a presentation on a display and/or opening a web browser to a web page for registration) in response to execution of the carrier profile, as no corresponding manual counterpart, since the applet requires a processor for execution.

At least some implementation of the systems, methods, devices, and code instructions described herein address the technical problem of improving a computer that manages multiple carrier profiles allocated to different mobile devices. At least some implementation of the systems, methods, devices, and code instructions described herein improve the technical field of managing multiple carrier profiles allocated to different mobile devices. Cellular provides limit the ability to download carrier profiles to mobile devices. Those users that are likely to register their carrier profiles for cellular services by a cellular carrier are provided with instructions on how to download the carrier profile to their mobile devices, for example, by scanning a QR code. This is because carrier profiles that are downloaded to mobile devices, but are not activated, represent a lost digital asset, which is still centrally managed by a computer. The carrier profile, which is not being used cannot be released and re-allocated to another mobile device. The computer allocates processing resources and/or memory for managing these allocated but unused carrier profiles which cannot be released and re-allocate to other mobile devices.

At least some implementation of the systems, methods, devices, and code instructions described herein address the above mentioned technical problem, and/or improve the above mentioned technical field, and/or improve upon the above mentioned existing approaches, by providing an applet that is included within the carrier profile that monitors the registration process and/or monitors use of the carrier profile. The applet detects whether the registration process has not been initiated or not completed, and/or whether the carrier profile is not being used (e.g., for at least a defined amount of time). The applet may send a message to a server of the cellular indicating that the carrier profile may be released for allocation to another mobile device. The applet may locally modify the carrier profile to render the carrier profile inoperable, to prevent a situation in which the user then attempts to register with the carrier profile which has already been allocated to another mobile device.

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

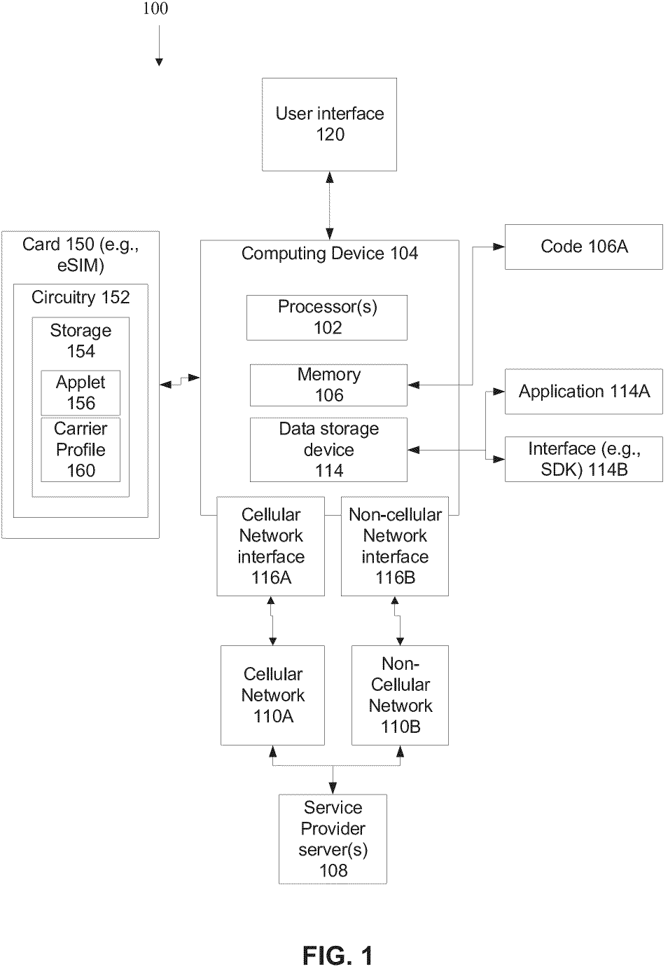

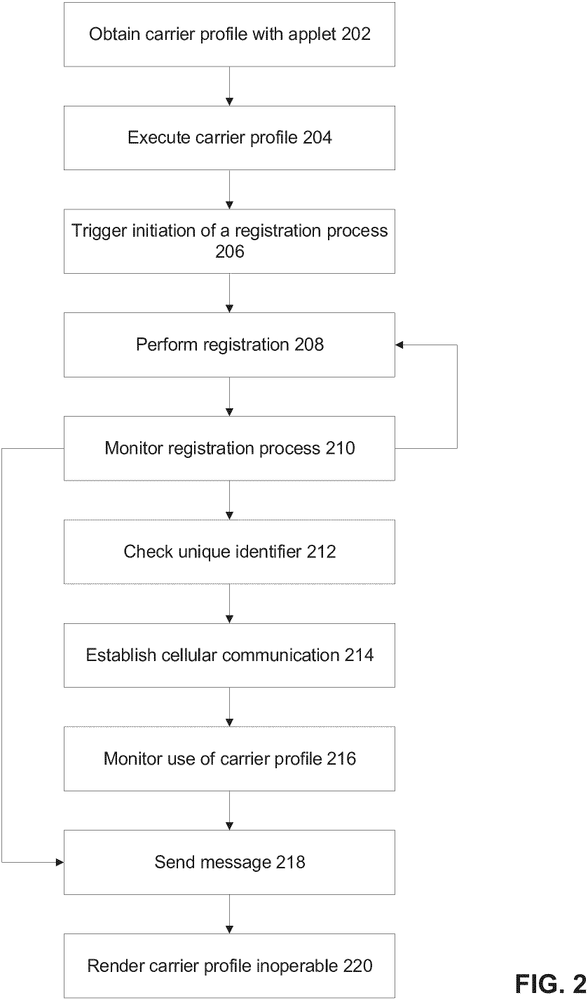

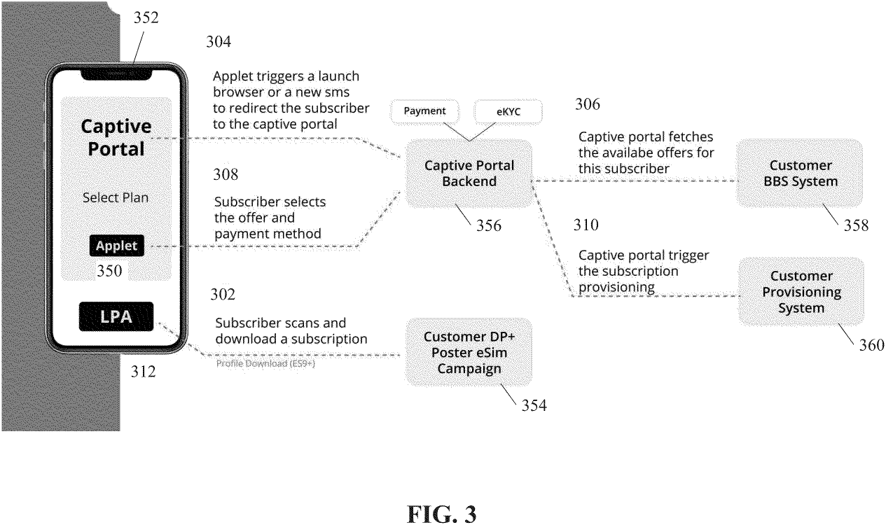

Reference is now made to FIG. 1, which is a block diagram of components of a system 100 for on-device setup of a mobile device using an applet 156 within a carrier profile 160, in accordance with some embodiments of the present invention. Reference is also made to FIG. 2, which is a flowchart 200 of a method of on-device setup of a mobile device using an applet within a carrier profile, in accordance with some embodiments of the present invention. Reference is also made to FIG. 3, which is an example of dataflow for establishing cellular communication with a mobile device using an applet within a carrier profile, in accordance with some embodiments of the present invention.

System 100 may implement the acts of the method described with reference to FIGS. 2-3 by processor(s) 102 of a computing device 104 executing code instructions, including code stored in an applet 156 which is stored on a storage device 154 of circuitry 152, which may be located on a card 150. Processor(s) 102 may execute other code stored on computing device 104, for example, application 114A, interface (e.g., SDK, API) 114B, and/or code 106A, stored on a memory 106 and/or on a data storage device 114.

Card 150 may be, for example, an e SIM card that is embedded in computing device 104. In other implementations, card 150 may be a SIM card that is inserted into a slot of the computing device.

Card 150 includes circuitry 152, which may include a storage component 154 storing applet 156, as described herein.

A carrier profile 160 may be obtained and stored in association with eSIM 150, optionally within storage 154. Carrier profile 160 may be implemented, for example, as code instructions stored on a memory region of circuitry 152. Carrier profile 160 enables using eSIM 150 to obtain cellular services provided by a cellular carrier. eSIM 150 remains constant, while different carriers provide different carrier profiles 160, to enable switching between carriers by changing carrier profiles 160 without changing eSIM 150 cards. This is in contrast to using physical SIM cards where in order to switch carriers the user physical switches between SIM cards. Carrier profile 160 may be obtained, for example, from a service provider server(s) 108, optionally by applet 156.

Applet 156 may be implemented, for example, as code instructions stored on a memory region of circuitry 152 and/or as hard-wired instructions. Applet 156 may be, for example, a program loaded into storage 154 by an external provider, for example, code of applet 156 is sent to cellular providers for loading on eSIM cards that installed within eSIM cards 150 of different computing devices 104. Applet 156 may be included within carrier profile 160, optionally downloaded over a network. Alternatively or additionally, applet 156 may be, for example, an existing identifier, an existing applet, and an existing code previously loaded on the circuitry 152 (e.g., hard-wired therein such as a unique identifier) and/or stored in storage 154, for example, by the cellular provider.

Computing device 104 may be implemented as, for example one or more and/or combination of: a mobile device (e.g., a Smartphone, a Tablet computer, a laptop computer, a wearable computer, glasses computer, and a watch computer), user equipment (UE), mobile station (MS), a camera, a computer, internet of things (IoT) device, a cellular modem, and a cellular hotspot, The computing device 104 may refer to, for example, a group of connected devices, a single client terminal, a server, a virtual server, a computing cloud, a virtual machine, a desktop computer, a thin client, a network node, and the like.

Hardware processor(s) 102 of computing device 104 may be implemented, for example, as a central processing unit(s) (CPU), a graphics processing unit(s) (GPU), field programmable gate array(s) (FPGA), digital signal processor(s) (DSP), and application specific integrated circuit(s) (ASIC). Processor(s) 102 may include a single processor, or multiple processors (homogenous or heterogeneous) arranged for parallel processing, as clusters and/or as one or more multi core processing devices.

Memory 106 stores code instructions 106A executable by hardware processor(s) 102, for example, a random access memory (RAM), read-only memory (ROM), and/or a storage device, for example, non-volatile memory, magnetic media, semiconductor memory devices, hard drive, removable storage, and optical media (e.g., DVD, CD-ROM). Memory 106 storing code 106A may implement one or more features and/or acts of the method described with reference to FIGS. 2-3 when executed by hardware processor(s) 102.

Computing device 104 may include a data storage device 114 for storing data, for example, one or more applications 114A which may be initially installed for setting up the cellular communication services as described herein, and/or interface 114B used to interface with applet 156 (e.g., software development kit (SDK) and/or application programming interface (API)), as described herein. Data storage device 114 may be implemented as, for example, a memory, a local hard-drive, virtual storage, a removable storage unit, an optical disk, a storage device, and/or as a remote server and/or computing cloud (e.g., accessed using a network connection).

There may be two or more networks 110A-B. Network 110A is a cellular network 110A. To connect to cellular network 110A, eSIM 150 with carrier profile 160 is used. Registration with a cellular carrier is performed to enable using cellular network 110A. Network 110B is a non-cellular network 110B. To connect to cellular network 110B, eSIM 150 and/or carrier profile 160 are not used. Carrier profile 160 and/or applet 156 and/or application 114A may be downloaded over non-cellular network 110B, such as prior to computing device 104 being setup to communicate over cellular network 110A, as described herein. Network 110B may be implemented as, for example, the internet, a local area network, a virtual network, and a wireless network.

Computing device 104 may include a network interface 116A for connecting to network 110A, for example, a cellular interface for connecting to the cellular network (e.g., antenna). Computing device 104 may include a network interface 116B for connecting to network 110B. Each network interface 116A-B may be implemented as, for example, one or more of, a network interface card, a wireless interface to connect to a wireless network, a physical interface for connecting to a cable for network connectivity, a virtual interface implemented in software, network communication software providing higher layers of network connectivity, and/or other implementations.

Computing device 104 communicates over network 110A and/or 110B with service provider server 108 for example, for obtaining carrier profile 160, applet 156, and/or registering for cellular services, as described herein.

Computing device 104 includes and/or is in communication with one or more physical user interfaces 120 that include a mechanism for a user to enter data and/or view data. Exemplary user interfaces 120 include, for example, one or more of, a touchscreen, a display, a virtual reality display (e.g., headset), gesture activation devices, a keyboard, a mouse, and voice activated software using speakers and microphone.

Referring now back to FIG. 2, at 202, a carrier profile with applet therein is obtained by the mobile device from a server. The carrier profile with applet may be downloaded, for example, over a limited package cellular network, and/or over a non-cellular network connection such as a Wi-Fi connection to the internet.

The mobile device may access a server hosting the carrier profile with applet therein, for example, by scanning a QR code, opening a link sent by SMS or a system message coming from the eSIM profile, opening a link sent by email, the user manually entering the address of the server, from a removable storage device, and the like.

The carrier profile implemented as code, includes the applet as code, for example, as a separate piece of applet code downloaded with the carrier profile, as applet code included within the code of the carrier profile, and the like.

The carrier profile with applet is stored in the storage compartment of the circuity, optionally in an eSIM card. In the implementation of eSIM, the carrier profile is designed for use with the eSIM.

At 204, the carrier profile that includes the applet is executed by the processor(s) of the mobile device. Alternatively or additionally, the applet within the carrier profile is executed by the processor(s) of the mobile device. The execution may be automatically triggered upon completion of the download of the carrier profile.

At 206, the applet automatically triggers initiation of a registration process.

The registration process may be triggered automatically by the applet upon completion of the download and installation of the carrier profile.

The applet may trigger initiation of the registration process, for example, by triggering a presentation, optionally including a message, on a display of the mobile device. The presentation may be a pop-up box presented on the display. The presentation may be interactive, including icons to enable the user to proceed with the registration process, or cancel the registration process.

Alternatively or additionally, the applet may trigger a connection to a web page hosting the registration process, for example, by automatically opening up a browser window with the address of the web page. The connection may be over a limited cellular network, and/or over a non-cellular network (e.g., Wi-Fi and/or internet). It is noted that the connection to the web page may be initially established, or established after the user selects to continue with the registration via the presentation (e.g., by clicking ‘ok’).

The registration process is for registration with a service provider for establishing cellular communication with the service provider using the circuitry (e.g., eSIM) in association with the carrier profile.

At 208, the user registers following the registration process, optionally via the connected web page. For example, the user establishes a new account, and enters user credentials, billing information, and/or selects a cellular plan. In another example, the user accesses a pre-existing account.

At 210, the applet monitors the registration process on the mobile device. The applet monitors the registration process for detecting a lack of initiation of the registration process, a cancellation of the registration process, and/or a pause in progress of the registration process.

For example, the applet monitors the presentation (e.g., window with message) presented on a display for detecting whether a user performs one of: entering an indication to confirm to proceed with the registration process (i.e., desired outcome), entering an indication to terminate the registration process (i.e., detected termination of registration), and not providing a selection with respect to the registration process (i.e., detected pause or lack of initiation of registration).

The applet may monitor the registration process on the mobile device with a virtual interface (e.g., software development kit (SDK), application programming interface (API)) designed to communicate with processes (e.g., applications, presentations) running on the mobile device, externally to the applet and/or carrier profile. The applet may establish a communication session with the window presented on the display and/or with the open web browser for monitoring thereof, via the virtual interface.

When the applet detects that the registration process has not been initiated, paused, or is cancelled, the flow of the method proceeds to 218.

At 212, the applet access a unique identifier that uniquely identifies the circuitry. The unique identifier may be used for validating that the carrier profile is installed on a real physical mobile device, i.e., that the carrier profile has not been stolen and used, for example, installed on a desktop by hackers that stole many

At 214, upon completion of the registration, the mobile device sends and/or receives data and/or voice traffic over a cellular communication network using a registration account established by the registration process.

At 216, the applet may monitor use of the carrier profile by the applet. The applet may monitor the carrier profile for detecting lack of use of the carrier profile, for example, exceeding a time threshold. For example, the carrier profile has not been used to send and/or receive data over the cellular network for at least about 1 day, or 3 days, or 7 days, or 1 week, or 1 month, or other values. The applet may detect that another carrier profile is being used to send and receive data over another cellular network, while an original carrier profile is not being used.

When the applet detects that the carrier profile registration process has not been initiated, paused, or is cancelled, the flow of the method proceeds to 218.

At 218, in response to detecting the lack of initiation, pause, or cancellation of the registration process, and/or in response to detecting the lack of use of the carrier profile, the applet sends a message to a server, optionally of the service provider. The service provider may release the carrier profile from the mobile device in response to the message.

Once the carrier profile has been downloaded by the mobile device, the cellular carrier cannot release the carrier profile and assign it to another mobile device unless the cellular carrier is certain that the mobile device is not using and will not be using the carrier profile. The monitoring by the applet finds carrier profiles that are not used, enabling releasing of those carrier profiles, and re-assignment of the carrier profiles to other mobile devices. Carrier profiles that are downloaded on mobile devices but are not being used are an extra burden on computers that manage the carrier profiles. The computer allocates memory, data storage, and/or processing resources to manage the unused carrier profiles. Allowing release and re-allocation of unused carrier profiles reduces the total number of carrier profiles being managed, which improves utilization of the resources of the computer managing the carrier profiles.

At 220, the applet may adapt the carrier profile to render the carrier profile inoperable for use for cellular communication. For example, the applet may delete code of the carrier profile to prevent the carrier profile from being used for cellular communication. The adapting of the carrier profile to render the carrier profile inoperable allows for the cellular provider to release the carrier profile from the mobile device, and assign the carrier profile to another mobile device, without risk of the original mobile device attempting to use the same carrier profile, i.e., avoiding a situation where two mobile devices are assigned and using the same carrier profile.

Referring now back to FIG. 3, the features described with reference to FIG. 3 may correspond to and/or may include features of the method described with reference to FIG. 2. It is noted that components described with reference to FIG. 3 are exemplary and

At 302, a carrier profile with applet 350 therein is download on a mobile device 352 from a server 354, for example, by scanning a QR code.

At 304, applet 350 triggers initiation of a registration process. For example, applet 350 triggers a launch of a browser to access a captive portal 356, and/or sends a message requesting an SMS be sent to the mobile device for accessing captive portal 356.

At 306, offers available to the subscribes may be fetches from a data storage device 358.

At 308, the subscriber performs the registration, for example, by selecting the offer and/or payment method.

At 310, captive portal 356 accesses a server 360 for triggering provisioning of cellular network services to mobile device 352 based on the registration data.

At 312, mobile device 352 is connected to the cellular network using the eSIM and carrier profile with applet.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is expected that during the life of a patent maturing from this application many relevant eSIM cards and carrier profiles will be developed and the scope of the terms eSIM cards and carrier profiles are intended to include all such new technologies a priori.

As used herein the term “about” refers to ± 10%.

The terms “comprises”, “comprising”, “includes”, “including”, “having” and their conjugates mean “including but not limited to”. This term encompasses the terms “consisting of” and “consisting essentially of”.

The phrase “consisting essentially of” means that the composition or method may include additional ingredients and/or steps, but only if the additional ingredients and/or steps do not materially alter the basic and novel characteristics of the claimed composition or method.

As used herein, the singular form “a”, “an” and “the” include plural references unless the context clearly dictates otherwise. For example, the term “a compound” or “at least one compound” may include a plurality of compounds, including mixtures thereof.

The word “exemplary” is used herein to mean “serving as an example, instance or illustration”. Any embodiment described as “exemplary” is not necessarily to be construed as preferred or advantageous over other embodiments and/or to exclude the incorporation of features from other embodiments.

The word “optionally” is used herein to mean “is provided in some embodiments and not provided in other embodiments”. Any particular embodiment of the invention may include a plurality of “optional” features unless such features conflict.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

It is the intent of the applicant(s) that all publications, patents and patent applications referred to in this specification are to be incorporated in their entirety by reference into the specification, as if each individual publication, patent or patent application was specifically and individually noted when referenced that it is to be incorporated herein by reference. In addition, citation or identification of any reference in this application shall not be construed as an admission that such reference is available as prior art to the present invention. To the extent that section headings are used, they should not be construed as necessarily limiting. In addition, any priority document(s) of this application is/are hereby incorporated herein by reference in its/their entirety.

What is claimed is:

1. A method for on-device setup, comprising:
using at least one processor of a mobile device for:
executing a carrier profile including an applet stored in a storage component of circuitry of the mobile device; and
triggering, by the applet stored in the storage component of the circuitry, initiation of a registration process for registration with a service provider for establishing cellular communication with the service provider using the circuitry in association with the carrier profile.

2. The method of claim 1, further comprising sending and receiving data over a cellular communication network using a registration account established by the registration process.

3. The method of claim 1, further comprising:
monitoring the registration process by the applet for detecting a lack of initiation or pause in progress; and
in response to detecting the lack of initiation or pause, sending by the applet a message to the server of the service provider for releasing the carrier profile from the mobile device.

4. The method of claim 3, further comprising adapting the carrier profile to render the carrier profile inoperable for use for cellular communication.

5. The method of claim 4, wherein render the carrier profile inoperable comprises deleting code of the carrier profile.

6. The method of claim 3, wherein monitoring the registration process for detecting a lack of initiation or pause in progress comprises: monitoring a message presented on a display for detecting whether a user performs one of: entering an indication to confirm to proceed with the registration process, entering an indication to terminate the registration process, and not providing a selection with respect to the registration process.

7. The method of claim 3, wherein the applet monitors a process running on the mobile device that enables performing the registration process via a communication session established between the applet and the process via a virtual interface of the applet.

8. The method of claim 1, further comprising monitoring use of the carrier profile by the applet for detecting lack of use of the carrier profile exceeding a time threshold, and in response to detecting the lack of use of the carrier profile, sending by the applet a message to a server of the service provider for releasing the carrier profile from the mobile device.

9. The method of claim 1, wherein the carrier profiled with applet therein is obtained from a server over a limited package cellular network.

10. The method of claim 1, wherein the registration process is triggered automatically by the applet upon completion of download and installation of the carrier profile.

11. The method of claim 1, wherein the applet triggers a message presented on a display of the mobile device for initiating the registration process in response to an indication entered by a user.

12. The method of claim 1, wherein the applet triggers a connection over a limited cellular network to a web page hosting the registration process.

13. The method of claim 1, further comprising, accessing by the applet, a unique identifier that uniquely identifies the circuitry for validating that the carrier profile is installed on a real physical mobile device.

14. The method of claim 13, wherein the unique identifier is selected from a group comprising: a unique embedded identity document (EID), eSIM ID, and International Mobile Equipment Identity (IMEI).

15. The method of claim 13, further comprising sending a message indicating the unique identifier to a server for establishment of the cellular communication over a cellular network.

16. The method of claim 1, wherein the circuitry comprises an embedded subscriber identity module (eSIM) and the carrier profile comprises an eSIM carrier profile.

17. A system for on-device setup, comprising:
at least one processor of a mobile device executing a code for:
executing a carrier profile including an applet stored in a storage component of circuitry of the mobile device; and
triggering, by the applet stored in the storage component of the circuitry, initiation of a registration process for registration with a service provider for establishing cellular communication with the service provider using the circuitry in association with the carrier profile.

18. A non-transitory medium of a mobile device storing program instructions for on-device setup, which, when executed by a processor of the mobile device, cause the processor to:
execute a carrier profile including an applet stored in a storage component of circuitry of the mobile device; and
trigger, by the applet stored in the storage component of the circuitry, initiation of a registration process for registration with a service provider for establishing cellular communication with the service provider using the circuitry in association with the carrier profile.
